(19) United States
(12) Patent Application Publication
(10) Pub. No.: US 2002/0164106 A1
(43) Pub. Date: Nov. 7, 2002

(54) Optical disk device and optical pickup device

(76) Inventor: Takeshi Mizuno, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/030,993

(22) PCT Filed: May 30, 2001
(86) PCT No.: PCT/JP01/04571

(30) Foreign Application Priority Data
May 30, 2000 (JP) 2000-160979

(51) Int. Cl. G02B 6/27; G02B 6/26; G11B 7/00

(52) U.S. Cl. 385/11; 385/15; 369/110.01

(57) ABSTRACT

An optical disc drive includes a laser diode 21 which oscillates in multimiode, a first plane-of-polarization preserving fiber 33, and a second plane-of-polarization preserving fiber 36. The first plane-of-polarization preserving fiber 33 and second plane-of-polarization preserving fiber 36 form an optical path for transmitting the laser beam irradiated from the laser diode 21, and variation of polarization state which arises due to the transmission of the laser beam by one of the plane-of-polarization preserving fibers is compensated by the other of the plane-of-polarization preserving fibers. Thus, the beam can be transmitted with its polarization state maintained.

### TECHNICAL FIELD

The present invention relates to an optical disc drive for recording and/or reproducing information signals for an optical disc, and an optical pickup for irradiating a laser beam to an optical disc and detecting the laser beam reflected and returned therefrom.

### BACKGROUND ART

Conventionally, magneto-optical (MO) discs are used as optical discs to/from which data can be recorded/reproduced. The magneto-optical disc has a disc-shaped basal plate made of transparent material such as polycarbonate, and a signal recording layer made of magnetic material formed on the main surface of the basal plate. The basal plate shares its border surface with the signal recording layer, which works as the signal recording surface.

The signal recording surface has formed thereon concentrically or spirally formed recording tracks, and information signals are recorded along these recording tracks.

In recording/reproducing information signals to/from the optical disc, an optical disc drive having an optical pickup writes/reads information signals to/from the optical disc.

The optical pickup is so arranged as to face the signal recording surface of the optical disc, and irradiates a beam to the signal recording surface of the optical disc by condensing the beam by the use of an objective lens.

The optical pickup can write information signals to the signal recording surface of the optical disc by irradiating a beam to heat the surface and applying an external magnetic field thereto. And, the optical pickup can read information signals recorded on the signal recording surface of the optical disc by detecting rotation of polarization direction (Kerr effect) due to photomagnetic effect which arises on the signal recording surface to which the beam is irradiated.

On the other hand, an optical fiber for preserving a plane of polarization is used as an optical fiber which transmits a beam with a plane of polarization of the beam maintained.

When a beam whose plane of polarization coincides with either of a fast axis or a slow axis comes into a plane-of-polarization preserving optical fiber or an optical fiber which preserves a plane of polarization of a beam, since the difference of propagation constants of polarization modes which are perpendicular to each other is large and the polarization modes are hard to be combined therebetween, the polarization is preserved until the beam reaches the beam outgo terminal of the optical fiber.

The fast axis and the slow axis are axes of polarization with a difference of refractive index. A direction of a low refractive index is refelTed to as the fast axis, while a direction of a high refractive index, which is perpendicular to the fast axis, is referred to as the slow axis. As the plane-of-polarization preserving optical fiber, there are exemplified a PANDA type fiber which has two stress-imparting portions, and an ellipse jacket type fiber which has a dual structured clad and has its middle clad portion elliptically deformed so as to impart a stress to a core.

The plane-of-polarization preserving optical fiber is used to transmit a beam with the polarization state of the beam maintained when used as the beam-transmitting path.

As the light source of the optical disc drive for recording and/or reproducing information signals for the optical disc, a laser diode (LD) which oscillates in multimode is used so as to prevent the operation of the laser from being unstable due to the returned beam from the optical disc or optical system.

As the light source of the optical disc drive, besides the laser diode which oscillates in multimode with stability, a laser diode which superimposes appropriate high frequency on injected current or realizes self-excited pulsation, or other kinds of lasers which oscillate in multimode can be used.

Such optical disc drives using these kinds of laser sources are required to use an optical fiber at an optical path which transmit the laser beam to the optical disc as well as the returned beam from the optical disc so as to reduce the optical disc drive in weight and size.

However, conventional optical disc drives which use a light source such as the laser diode which oscillates in multimode, especially magneto-optical disc drives, cannot use an optical fiber at the optical path. That is, even though the plane-of-polarization preserving optical fiber is used, the laser beam cannot be transmitted with its polarization state maintained.

### DISCLOSURE OF THE INVENTION

Accordingly the present invention has an object to overcome the above-mentioned drawbacks of the prior art by providing an optical disc drive for recording and/or reproducing information signals for an optical disc by using an optical fiber for transmitting a beam to the optical disc at an optical path, and an optical pickup for irradiating a laser beam from a laser source to the optical disc and detecting the laser beam reflected and returned therefrom.

The above object can be attained by providing an optical disc drive for irradiating a laser beam to an optical disc to record and/or reproduce information signals, including a laser source which oscillates in multimode, a first plane-of-polarization preserving fiber, and a second plane-of-polarization preserving fiber; the first plane-of-polarization preserving fiber and the second plane-of-polarization preserving fiber forming an optical path for transmitting the laser beam irradiated from the laser source, variation of polarization state which arises due to the transmission of the laser beam by one of the plane-of-polarization preserving fibers being compensated by the other of the plane-of-polarization preserving fibers.

Also the above object can be attained by providing an optical disc drive for irradiating a laser beam to an optical disc to record and/or reproduce information signals, including a laser source which oscillates in multimode, a first phase difference plate, a plane-of-polarization preserving fiber, and a second phase difference plate; the laser beam of linear polarization irradiated from the laser source being changed to the laser beam of circular polarization or elliptical polarization by the first phase difference plate to be transmitted by the plane-of-polarization preserving fiber, and being changed to the laser beam of linear polarization by the second phase difference plate to be irradiated to the optical disc, and the returned laser beam of linear polarization from the optical disc being changed to the laser beam of circular polarization or elliptical polarization by the second phase difference plate to be transmitted by the plane-of-polarization preserving fiber, and being changed to the laser beam of linear polarization by the first phase difference plate.

Also the above object can be attained by providing an optical pickup, including a laser source which oscillates in multimode, a condensing lens for condensing a laser beam irradiated from the laser source to irradiate the condensed laser beam to an optical disc, and condensing the returned laser beam from the optical disc, a beam detecting means for detecting the returned laser beam from the optical disc condensed by the condensing lens, a first plane-of-polarization preserving fiber, and a second plane-of-polarization preserving fiber; the first plane-of-polarization preserving fiber and the second plane-of-polarization preserving fiber forming an optical path for transmitting the laser beam irradiated from the laser source, variation of polarization state which arises due to the transmission of the laser beam by one of the plane-of-polarization preserving fibers being compensated by the other of the plane-of-polarization preserving fibers.

Also the above object can be attained by providing an optical pickup, including a laser source which oscillates in multimode, a condensing lens for condensing a laser beam irradiated from the laser source to irradiate the condensed laser beam to an optical disc, and condensing the returned laser beam from the optical disc, a beam detecting means for detecting the returned laser beam from the optical disc condensed by the condensing lens, a first phase difference plate, a plane-of-polarization preserving fiber to which the laser beam from the first phase difference plate comes into, and a second phase difference plate; the laser beam of linear polarization irradiated from the laser source being changed to the laser beam of circular polarization or elliptical polarization by the first phase difference plate to be transmitted by the plane-of-polarization preserving fiber, and being changed to the laser beam of linear polarization by the second phase difference plate to be irradiated to the optical disc via the condensing lens, and the returned laser beam of linear polarization from the optical disc being condensed by the condensing lens and changed to the laser beam of circular polarization or elliptical polarization by the second phase difference plate to be transmitted by the plane-of-polarization preserving fiber, and being changed to the laser beam of linear polarization by the first phase difference plate to be transmitted to the beam detecting means.

### BRIEF DESCRIPTION OF THE DRAWINGS

FIG. 1 shows a block diagram of an optical disc drive according to the present invention.

FIG. 2 shows a sectional view of a head of the optical disc drive.

FIG. 3 shows a block diagram of an optical system of the optical disc drive.

FIG. 4 shows wavelength distribution of a laser diode which oscillates in multimode.

FIG. 5 shows the relation between variation of wavelength and rotational angle of a plane of polarization at a plane-of-polarization preserving fiber.

FIGS. 6A, 6B show rotations of the plane of polarization at the plane-of-polarization preserving fiber.

FIGS. 7A, 7B show polarization states at the plane-of-polarization preserving fiber.

FIG. 8 shows a block diagram of another example of an optical system of the optical disc drive.

### BEST MODE FOR CARRYING OUT THE INVENTION

The present invention will further be described below concerning the best modes for carrying out the present invention with reference to the accompanying drawings.

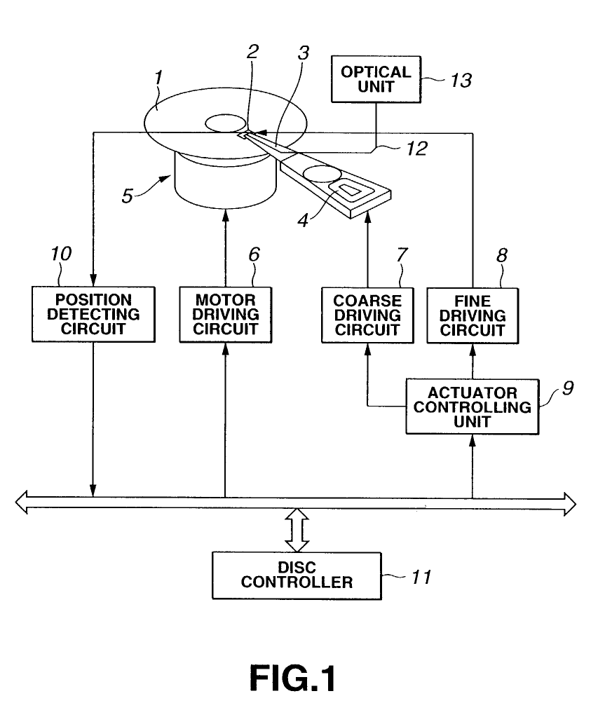

The present invention is applicable to an optical disc drive configured as shown in FIG. 1.

The optical disc drive shown in FIG. 1 records and/or reproduces information signals for an optical disc 1, and has two units or a recording/reproducing head unit and a beam receiving/irradiating unit and an optical system of an optical fiber 12 cojuiecting these two units.

The optical system of the optical disc drive uses a laser source which oscillates in multimode, and can transmit a laser beam by the use of an optical fiber with the polarization state of the laser beam maintained. An optical pickup is configured by the optical system.

When the optical disc drive records and/or reproduces information signals for the optical disc 1, a head actuator 4 moves a head 2 which is supported by a supporting spring 3 along substantially the radial direction of the optical disc 1. A voice coil notor (VCM), etc. is generally used as the head actuator 4. The optical disc drive further has a spindle motor 5 for rotating the optical disc 1, a motor driving circuit 6, a coarse driving circuit 7 for controlling the motion of the head actuator 4, a fine driving circuit 8 for finely moves a condensing system of the head 2 such as an objective lens, etc. by the use of a piezoelectric element, an actuator controlling unit 9 for controlling the coarse driving circuit 7 and fine driving circuit 8, a position detecting circuit 10 for detecting the position of the head 2, a disc controller 11, an optical unit 13 for detecting signals from the head 2, and the optical fiber 12 for optically connecting the head 2 and optical unit 13.

The head actuator 4 moves the head 2 along the radial direction of the optical disc 1 by rotating a rotating arm including the supporting spring 3 whose end supports the head 2. And, the head actuator 4 is driven by the coarse driving circuit 7.

The head 2 may be a floating type head of a sliding configuration which faces the optical disc 1 at a close position therefrom.

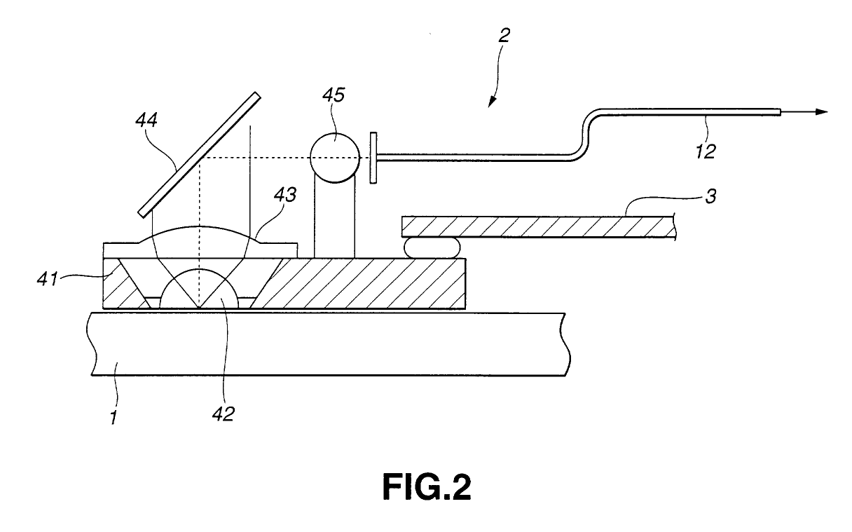

The head 2 has a slider 41 which faces the optical disc 1, a first lens 42 which is mounted to the slider 41 and is so arranged as to face the optical disc 1, and a second lens 43 which is mounted to the slider 41 and is arranged such that the first lens 42 is sandwiched by the optical disc 1 and the second lens 43, as shown in FIG. 2.

The head 2 further has a reflecting mirror 44 for varying the direction of an incoming/outgoing beam to/from the second lens 43 by substantially a right angle, and a third lens 45 which is mounted to the slider 41 and is so arranged as to be sandwiched by the optical fiber 12 and the reflecting mirror 44.

It is noted that thus configured floating type head is one example of the preferred embodiments of the head 2 according to the present invention, and the present invention is not limited to this embodiment.

In the optical disc drive shown in FIG. 1, the head 2 as a recording/reproducing head unit which faces the optical disc 1 and irradiates a beam thereto and receives a returned beam therefrom is configured separately fioni the optical unit 13 as a beam receiving/irradiating unit which has a laser source for irradiating a laser beam and a photo detecting element for detecting a laser beam. And, the head 2 and the optical unit 13 are connected by an optical path foxied by the optical fiber 12.

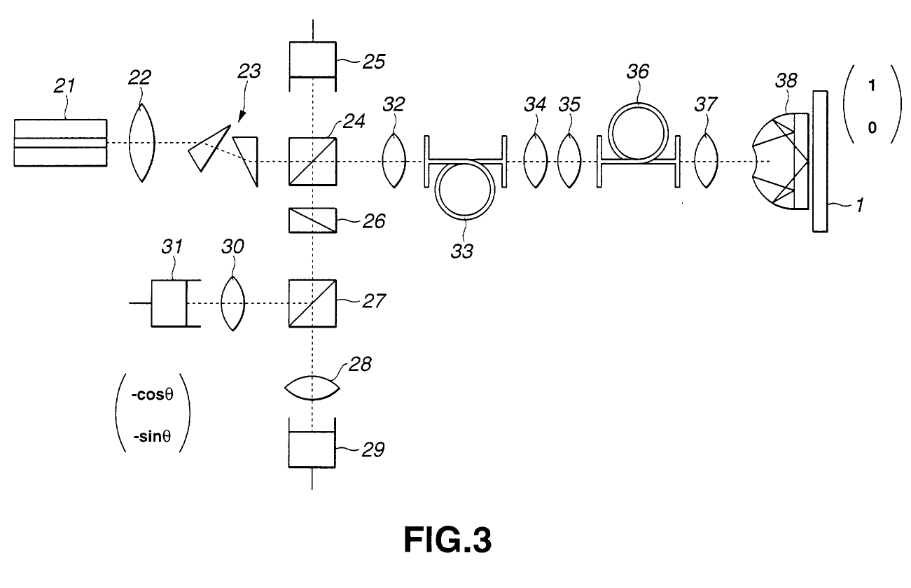

Next, the optical system of thus configured optical disc drive will be explained with reference to FIG. 3. In the explanation of the optical system, the optical unit 13 as a beam receiving/irradiating unit, head 2 as a recording/reproducing head unit, and optical fiber 12 which connects the optical unit 13 and head 2 will be explained in a manner following the laser beam which is transmitted along the optical path.

The optical system includes a semiconductor laser or a laser diode 21 as a laser source, a collimator lens 22 for collimating a beam irradiated from the laser diode 21, an anamorphic prism 23 for shaping the beam from the collimator lens 22, a non-polarization beam splitter 24 for splitting the beam from the anamorphic prism 23, and a first photodiode 25 for detecting the beam split by the non-polarization beam splitter 24. These components are positioned as a beam irradiating unit in the whole optical system, and belong to the beam receiving/irradiating unit.

In the beam receiving/irradiating unit, the laser diode 21 is driven by a current which is modulated by high frequency to irradiate a laser beam of multimode. The laser diode 21 can keep the state of the multimode oscillation stable due to the technique of superimposing high frequency.

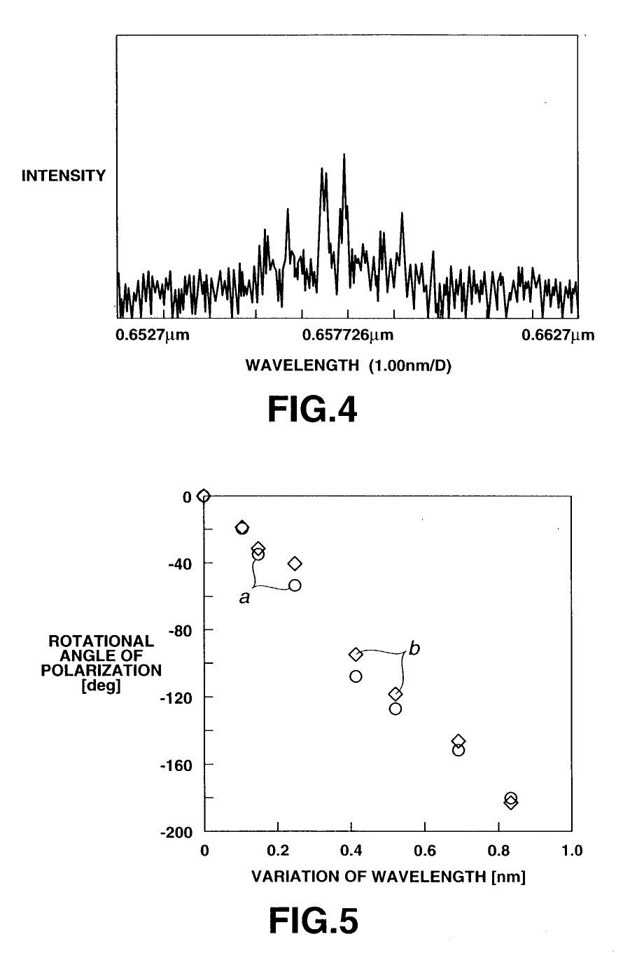

That is, the laser beam irradiated in multimode oscillation is not of a single wavelength, and is of multiple wavelengths, as shown in FIG. 4. That is, the laser beam has a constant wavelength distribution. In FIG. 4, one scale represents 1 in.

So as to suppress the influence due to the returned beam from the optical disc 1 or optical system, the laser diode 21 which irradiates a laser beam in multimode oscillation is employed. By employing the laser diode 21 which irradiates a laser beam of multimode, the influence due to the returned beam such as the mode hopping which is shown in a laser beam of single mode can be reduced.

The optical system further includes a first lens 32, a first plane-of-polarization preserving fiber 33, a second lens 34, a third lens 35, a second plane-of-polarization preserving fiber 36, a fourth lens 37, and an objective lens 38. In case the first plane-of-polarization preserving fiber 33 and second plane-of-polarization preserving fiber 36 are directly connected by fusion splicing, etc., the second lens 34 and third lens 35 are not used.

Of these components, the objective lens 38, fourth lens 37, and second plane-of-polarization preserving fiber 36 belong to the head 2 as the recording/reproducing head unit, while the others belong to the beam receiving/irradiating unit or optical fiber 12, which is not restricted. Specifically, both or either of the first plane-of-polarization preserving fiber 33 and second plane-of-polarization preserving fiber 36 correspond to the optical fiber 12 shown in FIG. 1. And, the objective lens 38 corresponds to the first lens 42 and second lens 43 of the head 2 shown in FIG. 2.

The first plane-of-polarization preserving fiber 33 receives a linearly polarized beam irradiated from the laser diode 21 via the first lens 32. At this time, the linearly polarized beam comes into the first plane-of-polarization preserving fiber 33 such that the plane of polarization of the lineally polarized beam coincides with either of the fast axis or the slow axis of the first plane-of-polarization preserving fiber 33.

The length of the first plane-of-polarization preserving fiber 33 is equal to that of the second plane-of-polarization preserving fiber 36. And, the first plane-of-polarization preserving fiber 33 and second plane-of-polarization preserving fiber 36 have their fast axes arranged perpendicular to each other. The polarization state of a laser beam of linear polarization which comes into outside of each axis is generally varied due to generation of phase rotation when the laser beam is transmitted. On the other hand, the first plane-of-polarization preserving fiber 33 and second plane-of-polarization preserving fiber 36 transmits a laser beam with the plane of polarization of the laser beam maintained as a whole by compensating a phase shift which arises at one of the plane-of-polarization preserving fibers with that which arises at the other of the plane-of-polarization preserving fibers.

When the beam irradiated from the laser diode 21 advances to the optical disc 1, the first lens 32 and third lens 35 work as convergent lenses for leading the beam to come into the optical axes of the first plane-of-polarization preserving fiber 33 and second plane-of-polarization preserving fiber 36, respectively, while the second lens 34 and fourth lens 37 work as collimator lenses for making the beam outgoing from the first plane-of-polarization preserving fiber 33 and second plane-of-polarization preserving fiber 36 parallel, respectively.

On the other hand, when the beam reflected and returned fi-om the optical disc 1 advances to a second photodiode 29 and a third photodiode 31, the fourth lens 37 and second lens 34 work as convergent lenses for leading the beam to come into the optical axes of the second plane-of-polarization preserving fiber 36 and first plane-of-polarization preserving fiber 33, respectively, while the third lens 35 and first lens 32 work as collimator lenses for making the beam outgoing firom the second plane-of-polarization preserving fiber 36 and first plane-of-polarization preserving fiber 33 parallel, respectively.

As the objective lens 38 which is so arranged as to face the optical disc 1 in the vicinity thereof, an SIM (Solid Imnersion Mirror) is used.

The optical system further includes a phase compensator 26 of a quarter-wave plate for compensating the phase of the beam which is returned from the optical disc 1 and reflected by the non-polarization beam splitter 24, a polarization beam splitter 27 for splitting the beam from the phase compensator 26 into an S wave and a P wave, a fifth lens 28 for converging the P wave which penetrates the polarization beam splitter 27, the second photodiode 29 for detecting the P wave which is converged by the fifth lens 28, a sixth lens 30 for converging the S wave whose direction is varied by substantially a right angle by the polarization beam splitter 27, and the third photodiode 31 for detecting the S wave which is converged by the sixth lens 30. These components are positioned as a beam receiving unit in the whole optical system, and belong to the beam receiving/irradiating unit.

Next, in the above-described optical system, the way how the beam irradiated from the laser diode 21 reaches the optical disc 1 will be explained.

The beam irradiated by the laser diode 21 is collimated by the collimator lens 22 and, then is shaped by the anamorphic prism 23 to come into the nonl-polarization beam splitter 24. Some of the beam which comes into the non-polarization beam splitter 24 is reflected and the direction thereof is varied by substantially a right angle to come into the first photodiode 25 as a front monitor for monitoring the power of the laser diode 21, where the beam is detected.

The beam which penetrates the non-polarization beam splitter 24 is converged by the first lens 32 and comes into the first plane-of-polarization preserving fiber 33 such that the plane of polarization of the beam coincides with either of the fast axis or the slow axis of the first plane-of-polarization preserving fiber 33. The beam which goes out from the first plane-of-polarization preserving fiber 33 is collimated by the second lens 34, and is converged by the third lens 35, and comes into the second plane-of-polarization preserving fiber 36. The beam which goes out from the second plane-of-polarization preserving fiber 36 is collimated by the fourth lens 37, and is condensed by the objective lens 38 to be irradiated to the optical disc 1.

Since the beam comes into the first plane-of-polarization preserving fiber 33 such that the plane of polarization of the beam coincides with either of the fast axis or the slow axis of the first plane-of-polarization preserving fiber 33, the beam is transmitted with its plane of polarization preserved. Furthermore, since the fast axis of the second plane-of-polarization preserving fiber 36 is perpendicular to that of the first plane-of-polarization preserving fiber 33, the beam which goes out from the first plane-of-polarization preserving fiber 33 comes into the second plane-of-polarization preserving fiber 36 such that the plane of polarization of the beam coincides with either of the fast axis or the slow axis of the second plane-of-polarization preserving fiber 36, which is the other axis different from the income axis into the first plane-of-polarization preserving fiber 33. Thus, the incoming beam is transmitted with its plane of polarization maintained.

Next, the way how the beam reflected and returned from the optical disc 1 reaches the second photodiode 29 and third photodiode 31 will be explained.

The returned beam from the optical disc 1 is collimated by the objective lens 38, and is converged by the fourth lens 37, and comes into the second plane-of-polarization preserving fiber 36. The beam which goes out from the second plane-of-polarization preserving fiber 36 is collimated by the third lens 35, and is converged by the second lens 34, and comes into the first plane-of-polarization preserving fiber 33. The beam which goes out from the first plane-of-polarization preserving fiber 33 is collimated by the first lens 32, and has its direction varied by substantially a right angle by the non-polarization beam splitter 24, and has it phase compensated by the phase compensator 26, and comes into the polarization beam splitter 27. The beam which comes into the polarization beam splitter 27 is split into the S wave and P wave. The P wave penetrates the polarization beam splitter 27, and is converged by the fifth lens 28 to come into the second photodiode 29, while the S wave has its direction varied by substantially a right angle by the polarization beam splitter 27, and is converged by the sixth lens 30 to come into the third photodiode 31.

The optical disc 1 used in the present invention is a disc whose data recorded thereon is read out using photomagnetic effect. That is, the plane of polarization of the returned beam from the optical disc 1 is rotated by a Kerr rotation angle against that of the beam irradiated to the optical disc 1 in accordance with data recorded by magnetization on magnetic material of the signal recording surface. Thus, so as to reproduce significant data from the optical disc 1, in transmitting the returned beam from the optical disc 1 to the beam receiving/irradiating unit which detects the returned beam, the state of the plane of polarization, that is, the angle of the plane of polarization should be preserved. The angle of the plane of polarization means a relative angle variation against the Kerr rotation angle.

As described above, according to the present invention, the angle of the plane of polarization is preserved by the combination of the first plane-of-polarization preserving fiber 33 and second plane-of-polarization preserving fiber 36. That is, the variation of the polarization state which arises when the returned beam from the optical disc 1 is transmitted by the second plane-of-polarization preserving fiber 36 is compensated by the first plane-of-polarization) preserving fiber 33.

Specifically, it is assumed that the P component and S component of the polarization components of the beam are represented as (xP, xS) and a linearly polarized beam of (1, 0) is irradiated fiom the laser diode 21. As described above, since the plane of polarization of the beam irradiated fi-om the laser diode 21 is preserved when the beam is transmitted, the components of the beam irradiated to the optical disc 1 via the objective lens 38 is (1, 0).

On the other hand, the components of the returned beam from the optical disc 1 detected by the second photodiode 29 and third photodiode 31 are (−cos θ, −sin θ). The angle θ corresponds to the Kerr rotation angle due to the photomagnetic effect generated at the optical disc 1.

The transmission of the returned beam from the optical disc 1 will be explained in more detail. The returned beam from the optical disc 1 comes into a portion other than the axis of the second plane-of-polarization preserving fiber 36 due to the Kerr rotation angle. Thus, the phase of the returned beam from the optical disc 1 which comes into the second plane-of-polarization preserving fiber 36 is caused to be rotated. That is, by employing the laser diode 21 which irradiates a laser beam in multimode oscillation, that is a laser beam having a wavelength distribution, along with the plane-of-polarization preserving fiber, the phase is caused to be rotated in accordance with the wavelength.

That is, as shown in FIG. 4, the laser beam irradiated from the laser diode 21 has a constant wavelength distribution of several nm. In FIG. 4, one scale represents 1 nm.

FIG. 5 shows measurement result of the phase rotation angle at the beam outgo terminal of the plane-of-polarization preserving fiber against the wavelength variation obtained by performing an experiment, in which a laser beam of single node having a wavelength of 657.121 nm comes into a portion other than the fast axis or slow axis of the plane-of-polarization preserving fiber with an angle of 45 degrees against the fast axis and slow axis. In FIG. 5, the point “a” represents the case in which the polarization ratio of the laser beam becomes maximum, while the point “b” represents the case in which the polarization ratio of the laser beam becomes minimum.

In FIG. 5, the phase is varied by s for the wavelength variation of 0.8 nm. In this way, even though there is generated slight wavelength perturbation, the variation of the polarization state at the beam outgo terminal of the plane-of-polarization preserving fiber becomes large.

As described above, since the laser beam irradiated from the laser diode 21 has a constant wavelength distribution of several mn, the phase variation distribution accordingly becomes significantly large.

The phase difference 6 between the fast axis and the slow axis of the plane-of-polarization preserving fiber is given as follows. The number of waves of the fast axis and slow axis are k1 and k2, respectively, while the refractive index thereof are n1 and n2, respectively. Optical path length of the plane-of-polarization preserving fiber is Z, reference wavelength is λ0, shift of wavelength X from the reference wavelength λ0 is δλ, and phase of one axis as a reference axis is δ0.

$$\begin{matrix}δ ∼ k1Z - k2Z \\ = Z \cdot ( n1 - n2 ) \cdot ( 2 π / λ 0 ) / ( 1 + δλ / λ0 ) \\ ∼ δ0 - δ 0 \cdot ( δλ / λ0 )\end{matrix}$$

Thus, the phase variation for the wavelength variation is given as follows.

Δδ=δ0·(δλ/λ0)

When the plane of polarization of the beam irradiated from the laser diode 21 comes into a portion other than the fast axis and slow axis of the plane-of-polarization preserving fiber, there is observed an elliptical polarization due to the phase rotation at the beam outgo terminal of the plane-of-polarization preserving fiber.

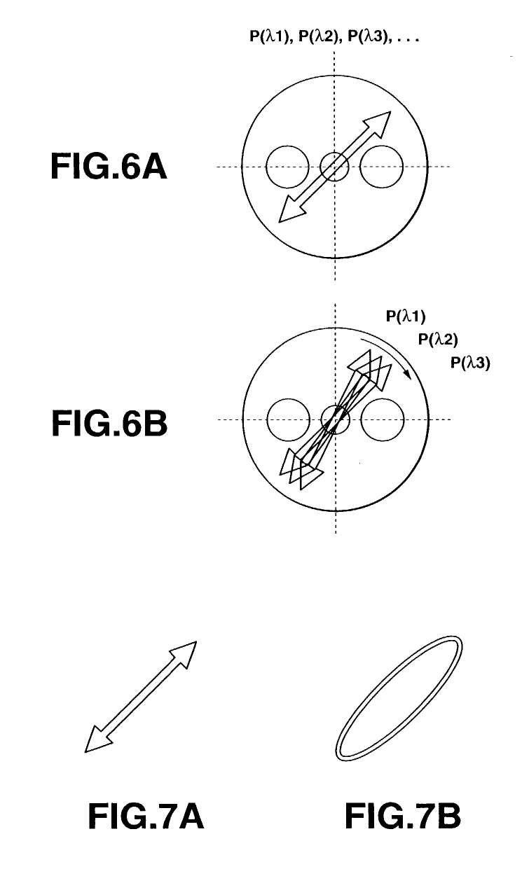

For example, as shown in FIG. 6A, it is assumed that a beam of λ1, λ2, λ3, with polarizations P (λ1), P (λ2), P (λ3), . . . which incline by 45 degrees against the fast axis and slow axis comes into the plane-of-polarization preserving fiber of the PANDA type.

As shown in FIG. 7A, the directions of the polarizations P (λ1), P (λ2), P (λ3), . . . are equal with each other, and a beam which is obtained by superposing these polarizations becomes a linearly polarized beam.

On the other hand, as described above, in the plane-of-polarization preserving fiber, the phase variation differs in accordance with the wavelengths λ1, λ2, λ3, . . . . Thus, at the beam outgo terminal of the plane-of-polarization preserving fiber, the states of polarizations P (λ1), P (λ2), P (λ3), . . . are different from each other, each with different ellipticity in accordance with the wavelengths λ1, λ2, λ3, . . . . FIG. 7B shows the polarization of the λ1, λ2, λ3, . . . .

In this way, the beam of multimode which comes into a portion other than the axis of the plane-of-polarization preserving fiber changes from the linear polarization to the elliptical polarization when the beam is transmitted by the plane-of-polarization preserving fiber. Thus, the signal-to-noise ratio (S/N) and the carrier-to-noise ratio (C/N) are reduced accordingly.

The optical system of the optical disc drive according to the present invention compensates the phase variation in accordance with wavelengths by combining the first plane-of-polarization preserving fiber 33 and second plane-of-polarization preserving fiber 36 as shown in FIG. 1. Thus, even though the returned beam from the optical disc 1 comes into a portion other than the axis of the second plane-of-polarization preserving fiber 36, a linearly polarized beam goes out from the first plane-of-polarization preserving fiber 33. So, according to the present invention, the signal-to-noise ratio (S/N) and the carrier-to-noise ratio (C/N) due to the change from the linear polarization to the elliptical polarization can be suppressed.

As described above, the optical disc drive according to the present invention records and/or reproduces data for an optical disc 1, which includes the head 2 as the recording/reproducing head unit, laser diode 21 as the beam receiving/irradiating unit, optical unit 13 having the second photodiode 29 and third photodiode 31, and optical fiber 12 such as the first plane-of-polarization preserving fiber 33 and second-plane-of-polarization preserving fiber 36 for connecting these components.

Thus configured optical disc drive can appropriately maintain the polarization state of the beam irradiated in multimode oscillation from the laser diode 21 of the optical unit 13, and transmit the beam to the head 2 to irradiate the beam to the optical disc 1. Also, the optical disc drive can appropriately maintain the polarization state of the returned beam from the optical disc 1, and transmit the beam from the head 2 to irradiate the second photodiode 29 and third photodiode 31 of the optical unit 13.

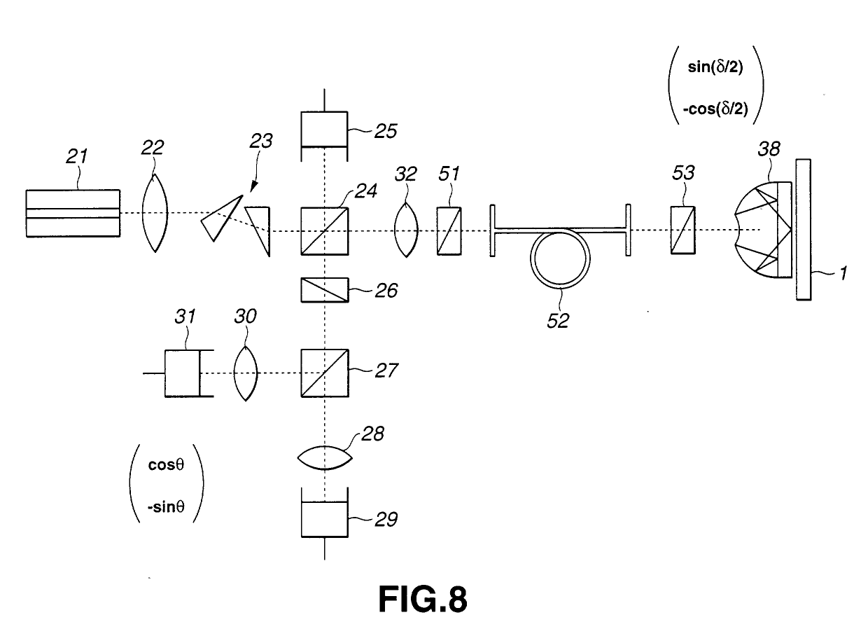

Next, another configuration of the optical system of the optical disc drive will be explained with reference to FIG. 8. In FIG. 8, the parts or components similar to those of the optical system shown in FIG. 3 are indicated with the same reference numerals, and the detailed explanation will be omitted.

The optical system includes the laser diode 21, collimator lens 22, anamorphic prism 23, non-polarization beam splitter 24.

The optical system further includes the first lens 32, a first quarter-wave plate 51, a plane-of-polarization preserving fiber 52, a second quarter-wave plate 53, and the objective lens 38.

The optical system further includes the phase compensator 26, polarization beam splitter 27, a second lens 28, a first photodiode 29, a third lens 30, and a second photodiode 31. The second lens 28 and third lens 30 shown in FIG. 8 correspond to the fifth lens 28 and sixth lens 30 shown in FIG. 3, respectively.

The plane-of-polarization preserving fiber 52 shown in FIG. 8 corresponds to the optical fiber 12 shown in FIG. 1.

In the optical system, the crystal optical axis of the first quarter-wave plate 51 inclines by 45 degrees against the plane of polarization of the linearly polarized beam irradiated from the laser diode 21 and transmitted via the non-polarization beam splitter 24. Also, the crystal optical axes of the first quarter-wave plate 51 and second quarter-wave plate 53 incline by 45 degrees against the fast axis of the plane-of-polarization preserving fiber 52.

The beam which penetrates the non-polarization beam splitter 24 is converged by the first lens 32 and comes into the first quarter-wave plate 51. The beam of linear polarization is changed to the beam of circular polarization by the first quarter-wave plate 51. The beam of circular polarization is transmitted by the plane-of-polarization preserving fiber 52, and then is changed to the beam of linear polarization again by the second quarter-wave plate 53. The beam which goes out from the second quarter-wave plate 53 is condensed by the objective lens 38 to be irradiated to the optical disc 1.

The returned beam from the optical disc 1 is condensed by the objective lens 38, and comes into the second quarter-wave plate 53. The beam oflinear polarization is changed to the beam of circular polarization or elliptical polarization by the second quarter-wave plate 53. The beam of circular polarization or elliptical polarization is transmitted by the plane-of-polarization preserving fiber 52, and then is changed to the beam of linear polarization again by the first quarter-wave plate 51. The beam which goes out from the first quarter-wave plate 51 is collimated by the first lens 32 to come into the non-polarization beam splitter 24.

The optical disc 1 according to the present invention has its data read out by detecting the Kerr rotation angle due to the photomagnetic effect. Thus, so as to reproduce significant data from the optical disc 1, in transmitting the returned beam, the angle of the plane of polarization should be preserved. In this another configuration, the angle of the plane of polarization is preserved by combining the first quarter-wave plate 51, plane-of-polarization preserving fiber 52, and second quarter-wave plate 53.

As described above, the laser beam irradiated in multimnode oscillation from the laser diode 21 has a constant wavelength distribution, as shown in FIG. 4. It is assumed that the P component and S component of the linearly polarized beamn irradiated from the laser diode 21 are (1, 0). Since the phase of the beam irradiated to the optical disc 1 via the first quarter-wave plate 51, plane-of-polarization preserving fiber 52, and second quarter-wave plate 53 is rotated in accordance with wavelength, rotation angle δ of the plane of polarization in accordance with wavelength such as (sin (δ/2), cos (δ/2)) is generated.

On the other hand, when the returned beam from the optical disc 1 is transmitted by the second quarter-wave plate 53, plane-of-polarization preserving fiber 52, and first quarter-wave plate 51, the returned beam has its rotation effect removed.

The components of the returned beam detected by the first photodiode 29 and second photodiode 31 are (−cos θ, −sin θ). The angle θ corresponds to the Kerr rotation angle due to the photomagnetic effect generated at the optical disc 1.

In this way, by combining the first quarter-wave plate 51, planie-of-polarization preserving fiber 52, and second quarter-wave plate 53, the effect of the rotation (sill (δ/2), cos (δ/2)) of the plane of polarization of the optical disc 1 is removed by the optical system when the beam reflected and returned from the optical disc 1 advances to a second photodiode 29 and a third photodiode 31, and only the angle θ due to the photomagnetic effect is generated.

As described above, according to the present invention, the beam receiving/irradiating unit and the recording/reproducing head Unit of the optical system are separated, and are connected by the plane-of-polarization preserving fiber. When the plane-of-polarization preserving fiber is employed as the beam-transmitting path, even though the beam irradiated from the laser diode which oscillates in multimode is used, the beam can be transmitted with its polarization state maintained between the beam receiving/irradiating unit and the recording/reproducing head unit.

Thus, according to the present invention, the head 2 as the recording/reproducing head unit is not required to have the beam receiving/irradiating unit. So, the head 2 can be reduced in weight and size, thereby data recorded on the optical disc 1 can be read out with high speed, while high speed accessing can be realized. Furthermore, since a floating type head can be employed due to the miniaturization of the head 2, the focusing servo unit which is mounted to the conventional optical disc drive becomes unnecessary.

Thus, by employing the plane-of-polarization presenting fiber, a magnetic recorder such as a hard disc drive provided with a plurality of heads can be realized.

Furthermore, according to the present invention, since the light source is not required to be mounted on the head, an inexpensive laser diode which oscillates in multimiode with stability can be selected.

In the above-described embodiment, ahead of a sliding configuration using near field is exemplified. On the other hand, the present invention is not restricted to the head. The present invention can be applied to an optical system of far field.

As in the above, according to the present invention, since the optical system has two limits which are connected by the optical fiber, even though the beam irradiated from the laser source which oscillates in multimode is used, the beam can be transmitted with its polarization state maintained.

Also, according to the present invention, a head for use in an optical magnetic apparatus for detecting data using photomagnetic effect can be realized,.

Furthermore, according to the present invention, since the optical system is composed of two units, the head can be reduced in size. By using the small-sized head, data recorded on the optical disc can be read out with high speed, while high speed accessing can be realized.

According to the present invention, by utilizing the small-sized head, since a floating type head can be employed, the focusing servo unit which is mounted to the conventional optical disc drive becomes unnecessary.

Also, according to the present invention, by connecting heads using the optical fiber, an optical disc drive provided with a plurality of heads can be realized easily.

Furthermore, according to the present invention, since the laser source is not required to be mounted on the head, the laser source can be selected from various ones, and an inexpensive laser source can be employed.

1. An optical disc drive for irradiating a laser beam to an optical disc to record and/or reproduce information signals, comprising:
a laser source which oscillates in multimode;
a first plane-of-polarization preserving fiber; and
a second plane-of-polarization preserving fiber;
the first plane-of-polarization preserving fiber and the second plane-of-polarization preserving fiber forming an optical path for transmitting the laser beam irradiated from the laser source, variation of polarization state which arises due to the transmission of the laser beam by one of the plane-of-polarization preserving fibers being compensated by the other of the plane-of-polarization preserving fibers.

2. The optical disc drive as set forth in claim 1, wherein the first plane-of-polarization preserving fiber and the second plane-of-polarization preserving fiber are of the same length, and each of the fibers has a fast axis and the fast axes of the fibers are perpendicular to each other.

3. The optical disc drive as set forth in claim 1, wherein the information signals recorded on the optical disc are read out by detecting rotation of a plane of polarization of the irradiated laser beam due to photomagnetic effect, and the first plane-of-polarization preserving fiber and the second plane-of-polarization preserving fiber transmit the returned laser beam from the optical disc with the state of the plane of polarization of the returned laser beam preserved.

4. An optical disc drive for irradiating a laser beam to an optical disc to record and/or reproduce information signals, comprising:
a laser source which oscillates in multimode;
a first phase difference plate;
a plane-of-polarization preserving fiber; and
a second phase difference plate;
the laser beam of linear polarization irradiated from the laser source being changed to the laser beam of circular polarization or elliptical polarization by the first phase difference plate to be transmitted by the plane-of-polarization preserving fiber, and being changed to the laser beam of linear polarization by the second phase difference plate to be irradiated to the optical disc, and the returned laser beam of linear polarization from the optical disc being changed to the laser bean of circular polarization or elliptical polarization by the second phase difference plate to be transmitted by the plane-of-polarization preserving fiber, and being changed to the laser beam of linear polarization by the first phase difference plate.

5. The optical disc drive as set forth in claim 4, wherein both of crystal optical axes of the first phase difference plate and the second phase difference plate incline by 45 degrees against a fast axis of the plane-of-polarization preserving fiber, and the linearly polarized beam from the laser source which inclines by 45 degrees against the crystal optical axis of the first phase difference plate comes into the first phase difference plate.

6. The optical disc drive as set forth in claim 4, wherein the information signals recorded on the optical disc are read out by detecting rotation of a plane of polarization of the irradiated laser beam due to photomagnetic effect, and the first phase difference plate, the plane-of-polarization preserving fiber, and the second phase difference plate transmit the returned laser beam from the optical disc with the state of the plane of polarization of the returned laser beam preserved.

7. An optical pickup, comprising:
a laser source which oscillates in multimode;
a condensing lens for condensing a laser beam irradiated from the laser source to irradiate the condensed laser beam to an optical disc, and condensing the returned laser beam from the optical disc;
a beam detecting means for detecting the returned laser beam from the optical disc condensed by the condensing lens;
a first plane-of-polarization preserving fiber; and
a second plane-of-polarization preserving fiber;
the first plane-of-polarization preserving fiber and the second plane-of-polarization preserving fiber forming an optical path for transmitting the laser beam irradiated from the laser source, variation of polarization state which arises due to the transmission of the laser beam by one of the plane-of-polarization preserving fibers being compensated by the other of the plane-of-polarization preserving fibers.

8. The optical pickup as set forth in claim 7, wherein the first plane-of-polarization preserving fiber and the second plane-of-polarization preserving fiber are of the same length, and each of the fibers has a fast axis and the fast axes of the fibers are perpendicular to each other.

9. The optical pickup as set forth in claim 7, wherein the information signals recorded on the optical disc are read out by detecting rotation of a plane of polarization of the irradiated laser beam due to photomagnetic effect, and the first plane-of-polarization preserving fiber and the second plane-of-polarization preserving fiber transmit the returned laser beam from the optical disc with the state of the plane of polarization of the returned laser beam preserved.

10. An optical pickup, comprising:
a laser source which oscillates in multimode;
a condensing lens for condensing a laser beam irradiated from the laser source to irradiate the condensed laser beam to an optical disc, and condensing the returned laser beam from the optical disc;
a beam detecting means for detecting the returned laser beam from the optical disc condensed by the condensing lens;
a first phase difference plate;
a plane-of-polarization preserving fiber; and
a second phase difference plate;
the laser beam of linear polarization irradiated from the laser source being changed to the laser beam of circular polarization or elliptical polarization by the first phase difference plate to be transmitted by the plane-of-polarization preserving fiber, and being changed to the laser beam of linear polarization by the second phase difference plate to be irradiated to the optical disc via the condensing lens, and the returned laser beam of linear polarization from the optical disc being condensed by the condensing lens and changed to the laser beam of circular polarization or elliptical polarization by the second phase difference plate to be transmitted by the plane-of-polarization preserving fiber, and being changed to the laser beam of linear polarization by the first phase difference plate to be transmitted to the beam detecting means.

11. The optical pickup as set forth in claim 10, wherein both of crystal optical axes of the first phase difference plate and the second phase difference plate incline by 45 degrees against a fast axis of the plane-of-polarization preserving fiber, and the linearly polarized beam from the laser source which inclines by 45 degrees against the crystal optical axis of the first phase difference plate comes into the first phase difference plate.

12. The optical pickup as set forth in claim 10, wherein the information signals recorded on the optical disc are read out by detecting rotation of a plane of polarization of the irradiated laser beam due to photomagnetic effect, and the first phase difference plate, the plane-of-polarization preserving fiber, and the second phase difference plate transmit the returned laser beam from the optical disc with the state of the plane of polarization of the returned laser beam preserved.
